(19) United States
(12) Patent Application Publication
(10) Pub. No.: US 2026/0230969 A1
(43) Pub. Date: Aug. 6, 2026

(54) METHODS FOR COORDINATED RELAY SELECTION IN WTRU-WTRU RELAYS

(71) Applicant: InterDigital Patent Holdings, Inc., Wilmington, DE (US)

(72) Inventors: Ananth Kini, Conshohocken, PA (US); Martino Freda, Laval (CA); Oumer Teyeb, Montreal (CA); Tuong Hoang, Montreal (CA); Jung Je Son, Warrington, PA (US); Michelle Perras, Montreal (CA)

(73) Assignee: InterDigital Patent Holdings, Inc., Wilmington, DE (US)

(21) Appl. No.: 19/149,052

(22) PCT Filed: Feb. 8, 2024
(86) PCT No.: PCT/US2024/014921

§ 371 Date: Jul. 17, 2025

Related U.S. Application Data
(60) Provisional application No. 63/445,371, filed on Feb. 14, 2023.

(51) Int. Cl. H04W 36/08; H04B 17/318; H04W 8/00; H04W 92/18

(52) U.S. Cl. CPC H04W 36/08; H04B 17/328; H04W 8/005; H04W 92/18

(57) ABSTRACT

A wireless transmit/receive unit (WTRU) may receive configuration information. The configuration information may include a sidelink reference signal receive power (SL-RSRP) threshold and/or a time period associated with discovery solicitation. The WTRU may determine whether radio link failure (RLF) has occurred on a PCS connection with a second WTRU or whether a SL-RSRP measurement on the PCS connection is below the SL-RSRP threshold. The WTRU may be based on a determination that RLF has occurred on the PCS connection with the second WTRU. The WTRU may send a solicitation message or a link modification message. The link modification message may include an indication of RLF detection on the PCS connection. The WTRU may receive an announcement message from a relay WTRU; select the relay WTRU for communication with the second WTRU; and send a release message to the second WTRU that causes the second WTRU to release the PCS connection.

### CROSS-REFERENCE TO RELATED APPLICATIONS

This application claims the benefit of U.S. Provisional Patent Application No. 63/445,371, filed on Feb. 14, 2023, the entire contents of which are incorporated herein by reference.

### BACKGROUND

Release 17 has specified SL-based wireless transmit/receive units (WTRU) to network relays. Sidelink relay may be introduced to support 5G ProSe WTRU-to-network relay (U2N relay) function to provide connectivity to the network for U2N remote WTRU(s). Both layer 2 (L2) and/or layer 3 (L3) U2N relay architectures may be supported. The L3 U2N relay architecture may be transparent to the serving RAN of the U2N relay WTRU, except for controlling sidelink resources.

A U2N relay WTRU may be in RRC_CONNECTED to perform relaying of unicast data. The L2 U2N relay operation may support several RRC state combinations. Both U2N relay WTRU and U2N remote WTRU may be in RRC CONNECTED to perform transmission and/or reception of relayed unicast data. The U2N relay WTRU may be in RRC_IDLE, RRC_INACTIVE and/or RRC_CONNECTED provided the U2N remote WTRU(s) connected to the U2N relay WTRU are either in RRC_INACTIVE and/or in RRC_IDLE.

For L2 U2N relay, the U2N remote WTRU may only be configured to use resource allocation mode 2 for data to be relayed. A single unicast link may be established between one L2 U2N relay WTRU and/or one L2 U2N remote WTRU. The traffic of U2N remote WTRU via a given U2N relay WTRU and/or the traffic of the U2N relay WTRU may be separated in different Uu radio link control (RLC) channels over Uu.

### SUMMARY

A first wireless/transmit receive unit (WTRU) maybe configured to receive configuration information. The configuration information may include a sidelink reference signal receive power (SL-RSRP) threshold and/or a time period associated with discovery solicitation. Ther WTRU may determine whether radio link failure (RLF) has occurred on a PC5 connection with a second WTRU or whether a SL-RSRP measurement on the PC5 connection is below the SL-RSRP threshold. The WTRU may base this determination on whether RLF has occurred on the PC5 connection with the second WTRU. The WTRU may send a solicitation message and/or a link modification message. The link modification message may include an indication of RLF detection on the PC5 connection. The WTRU may base this determination on whether the SL-RSRP measurement on the PC5 connection is below the SL-RSRP threshold. The WTRU may then receive an announcement message from a relay WTRU; select the relay WTRU for communication with the second WTRU; and/or send a release message to the second WTRU that causes the second WTRU to release the PC5 connection.

In response to the determination that RLF has occurred on the PC5 connection with the second WTRU, the first WTRU may wait for a response from a relay WTRU. The response may indicate that the second WTRU has received the solicitation message and/or the link modification message. The first WTRU may indicate that the second WTRU has selected the relay WTRU for performing sidelink communication with the first WTRU.

In response to the determination that the SL-RSRP measurement on the PC5 connection is below the SL-RSRP threshold, the first WTRU may send a solicitation message and/or link modification message to initiate relay selection after a determination that the first WTRU has not selected a new relay WTRU for the PC5 connection during the time period.

The first WTRU may send an indication message to the second WTRU. The indication message may indicate that the first WTRU has performed relay selection.

The first WTRU be configured as a primary WTRU. The primary WTRU may perform relay selection.

The first WTRU may send one or more announcement messages to perform relay selection. The first WTRU may switch the primary configuration and/or secondary configurations of the first WTRU and/or the second WTRU.

The first may send a solicitation message and/or a message comprising the reasons for triggering reselection or quality of service (QOS) data to the second WTRU to initiate relay selection if the first WTRU is a secondary WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts a user plane protocol stack for layer 2 (L2) WTRU-to-network relay.

FIG. 3 depicts a control plane protocol stack for L2 WTRU-to-network relay.

FIG. 4 depicts a protocol stack of discovery message for WTRU-to-network relay.

FIG. 5 depicts a WTRU-to-WTRU relay discovery with model A.

FIG. 6 depicts a WTRU-to-WTRU relay discovery with model B.

### DETAILED DESCRIPTION

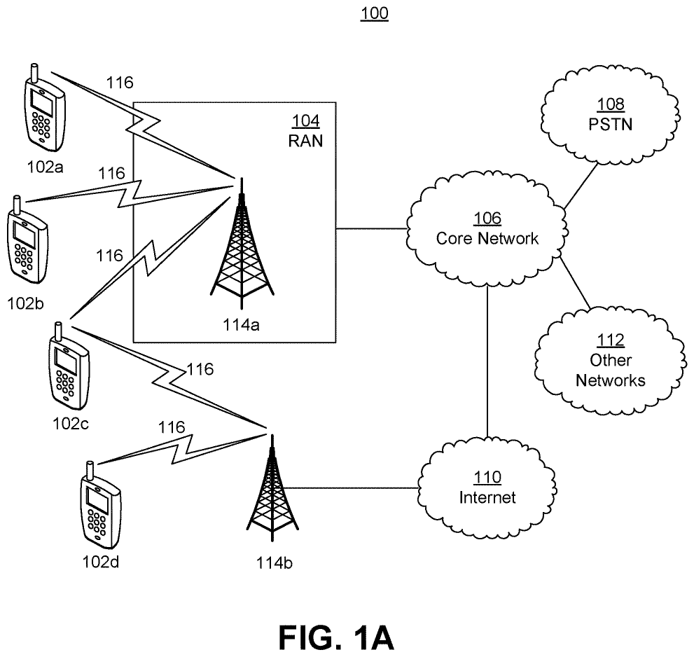

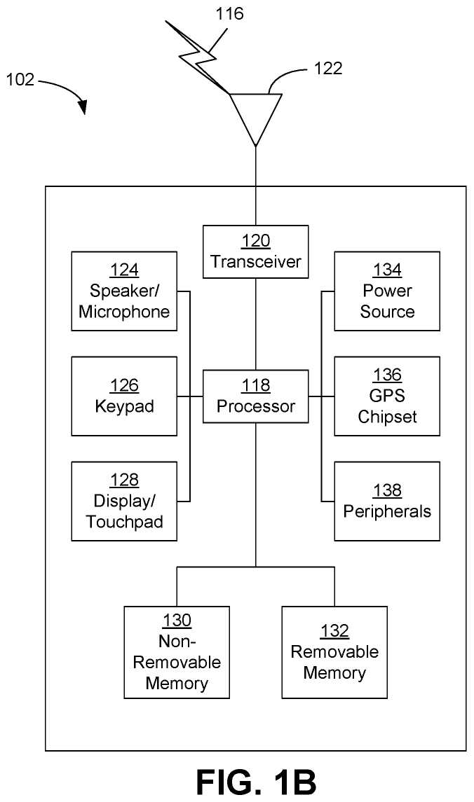

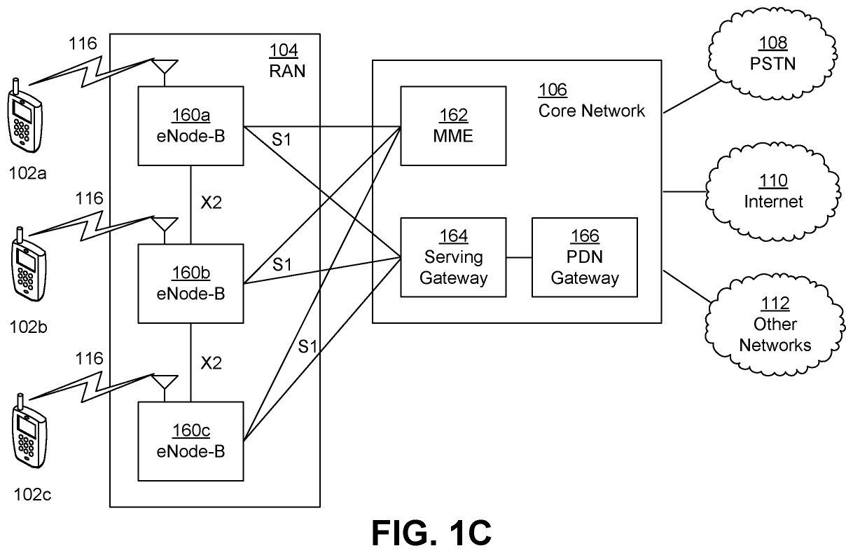

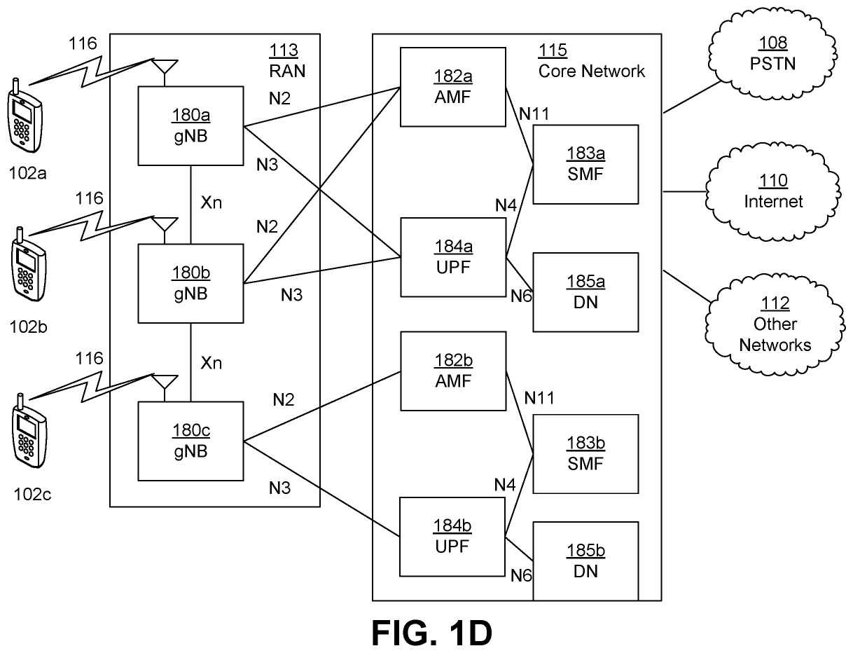

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102cmay implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth@ module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel.

The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

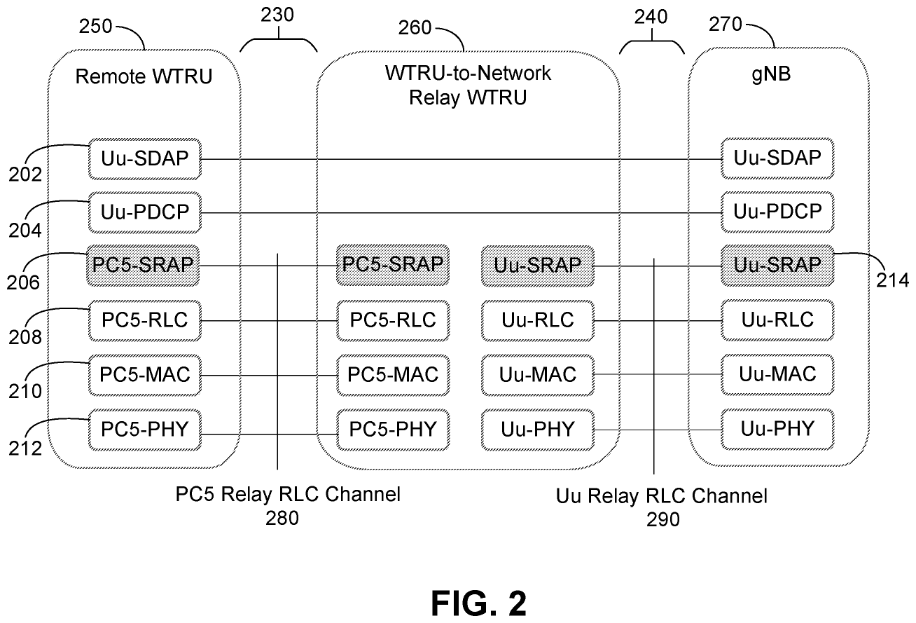

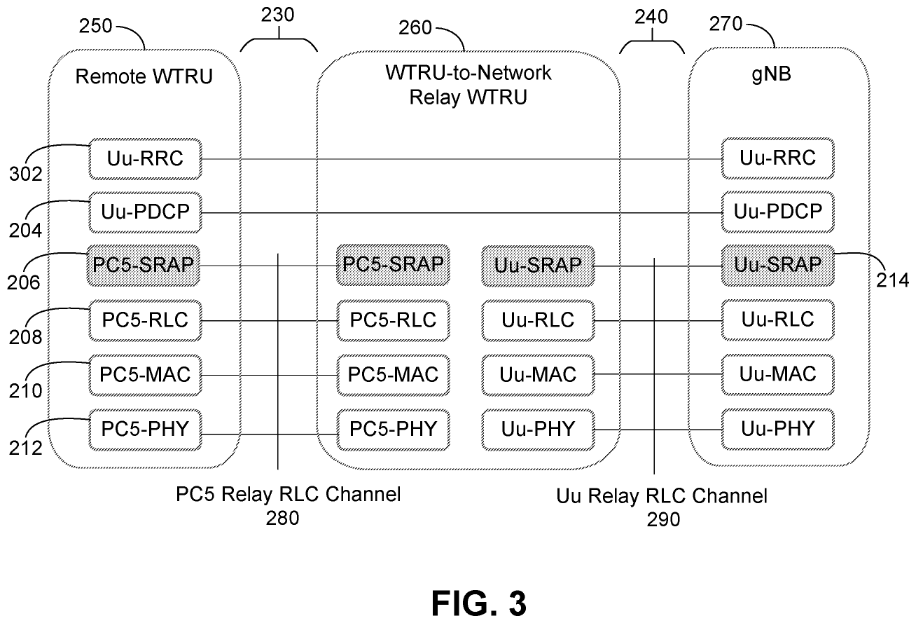

FIGS. 2 and 3 below depict the protocol stacks for the user plane (UP) and control plane (CP) of layer 2 (L2) U2N relay architecture, respectively. The sidelink relay adaptation protocol (SRAP) sublayer 206 may be placed above the radio link control (RLC) sublayer 208 for both UP and/or CP at both the PC5 interface 220 and/or the Uu interface 240. The Uu service data adaptation protocol (SDAP) 202, packet data convergence protocol (PDCP) 204, and/or radio resource control (RRC) 302 (as seen in FIG. 3) may be terminated between L2 U2N remote WTRU 250 and/or the network gNB 260. The SRAP sublayer 206, RLC sublayer 208, medium access control (MAC) sublayer 210, and physical layer (PHY) 212 may be terminated in each hop (e.g., PC5 hop 230 and/or Uu hop 240). The PC5 hop 230 refers to the link between L2 U2N remote WTRU 250 and/or the L2 U2N relay WTRU 260. The Uu hop 240 refers to the link between L2 U2N relay WTRU 260 and/or the gNB 270.

For L2 U2N Relay, the SRAP sublayer 206 over PC5 hop 230 may only serve the purpose of bearer mapping. The SRAP sublayer 206 may not be present over PC5 hop 230 for relaying the L2 U2N remote WTRU 250's message on the broadcast control channel (BCCH) and the paging control channel (PCCH). For L2 U2N remote WTRU 240's message on signaling radio bearer (SRB0), the SRAP sublayer 206 may not by present over PC5 hop 220. However, the SRAP sublayer 206 may be present over Uu hop 230 for both downlink (DL) and uplink (UL).

Regarding the L2 U2N relay 250 for uplink, the Uu SRAP sublayer 214 may support UL bearer mapping between ingress PC5 relay RLC channels 280 for relaying and/or egress Uu relay RLC channels 290 over the L2 U2N relay WTRU 260 Uu interface. For uplink relaying traffic, the different end-to-end resource blocks (RBs) (e.g., SRBs and/or data radio bearer (DRBs)) of the same remote WTRU 250 and/or different remote WTRU s may be multiplexed over the same Uu relay RLC channel 290.

The Uu SRAP sublayer 214 may support the L2 U2N remote WTRU 250 identification for the UL traffic. The Uu SRAP header may include identity information of the L2 U2N remote WTRU 250 Uu Radio Bearer and/or a local remote WTRU identifier (ID). The Uu SRAP header may include this information at UL in order for gNB 270 to correlate the received packets for the specific PDCP entity associated with the right Uu Radio Bearer of a remote WTRU 250. The PC5 SRAP sublayer 206 at the L2 U2N remote WTRU 250 may support UL bearer mapping between remote WTRU 250 Uu radio bearers and/or egress PC5 relay RLC channels 280.

Regarding the L2 U2N relay for downlink, the Uu SRAP sublayer 214 may support DL bearer mapping at gNB 270 to map end-to-end Radio Bearer (e.g., SRB and/or DRB) of remote WTRU 250 into Uu relay RLC channel 290 over relay WTRU Uu interface. The Uu SRAP sublayer 214 may support DL bearer mapping and/or data multiplexing between multiple end-to-end radio bearers (e.g., SRBs and/or DRBs) of a L2 U2N remote WTRU 250 and/or different L2 U2N remote WTRUs and/or one Uu relay RLC channel 290 over the relay WTRU Uu interface.

The Uu SRAP sublayer 214 may support remote WTRU 250 identification for DL traffic. At DL, the gNB 270 may include into the Uu SRAP header the identity information of remote WTRU Uu Radio Bearer and/or a local remote WTRU ID. The gNB 270 may make this inclusion for relay WTRU 250 to map the received packets from remote WTRU Uu Radio Bearer to its associated PC5 relay RLC channel 280.

The PC5 SRAP sublayer 206 at the relay WTRU 250 may support DL bearer mapping between ingress Uu relay RLC channels 290 and/or egress PC5 relay RLC channels 280.

The PC5 SRAP sublayer 206 at the remote WTRU 250 may correlate to the received packets for the specific PDCP entity associated with the right Uu Radio Bearer. The remote WTRU 250 may be based on the identity information included in the Uu SRAP header. The PC5 SRAP sublayer 206 may be responsible for data transfer for that maps the WTRU ID and/or Uu Radio Bearer ID to the RLC channel 280.

A local remote WTRU ID may be included in both the PC5 SRAP header and/or the Uu SRAP header. The gNB 270 may configure the L2 U2N relay WTRU 260 with the local remote WTRU ID. The local remote WTRU ID may be used in SRAP header. remote WTRU 250 may obtain the local Remote ID from the gNB via Uu RRC messages including RRCSetup, RRCReconfiguration, RRCResume, and/or RRCReestablishment. The Uu DRB(s) and/or the Uu SRB(s) may be mapped to different PC5 relay RLC channels 280 and/or the Uu relay RLC channels 290 in both PC5 hop 230 and/or Uu hop 240.

The gNB 270 may be responsible to avoid collision on the usage of local remote WTRU ID. The gNB 270 may update the local remote WTRU ID by sending the updated local Remote ID via RRCReconfiguration message to the relay WTRU 250. The serving gNB 270 may perform local remote WTRU ID update independently of the PC5 unicast link identifier (e.g., L2 ID) update procedure.

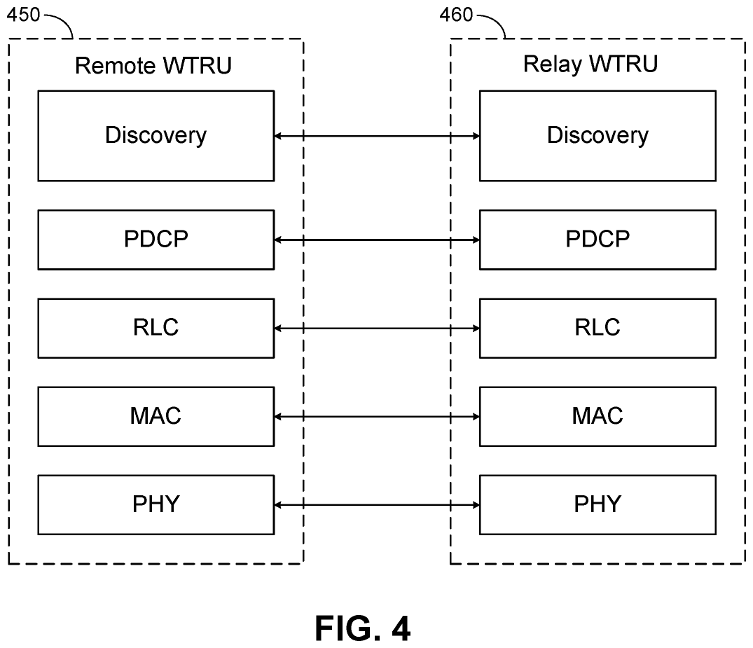

The model A and/or model B discovery models may be supported for U2N relay discovery. FIG. 4 depicts a protocol stack of discovery message for WTRU-to-Network relay.

The U2N remote WTRU 450 may perform relay discovery message transmission and may monitor the sidelink for relay discovery message while in RRC_IDLE, RRC_INACTIVE and/or RRC_CONNECTED. The network may broadcast a threshold. The U2N remote WTRU 450 uses this threshold to determine if the U2N remote WTRU 450 may transmit relay discovery solicitation messages to U2N relay WTRU(s) 460.

The U2N relay WTRU 460 may perform relay a discovery message transmission. The U2N relay WTRU 460 may monitor the sidelink for relay discovery message while in RRC_IDLE, RRC_INACTIVE and/or RRC_CONNECTED. The network may broadcast a maximum Uu reference signal received power (RSRP) threshold and/or a minimum Uu RSRP threshold. The U2N relay WTRU 460 may use the maximum Uu RSRP threshold and/or a minimum Uu RSRP threshold to determine if the U2N relay WTRU 460 can transmit relay discovery messages to U2N remote WTRU(s) 450.

The network may provide the relay discovery configuration using broadcast and/or dedicated signaling for relay discovery. Additionally or alternatively, the U2N Remote WTRU 450 and/or U2N relay WTRU 460 may use pre-configuration for relay discovery.

The resource pool(s) used for NR sidelink communication may be used for relay discovery and/or the network may configure a resource pool(s) dedicated for relay discovery. Resource pool(s) dedicated for relay discovery may be configured simultaneously with resource pool(s) for NR sidelink communication in system information, dedicated signaling, and/or pre-configuration.

Relay discovery may base its dedicated resource pool(s) on network implementation. In examples, if resource pool(s) dedicated for relay discovery are configured, those resource pool(s) dedicated for relay discovery may be used for Relay discovery. If resource pool(s) for NR sidelink communication are configured, all the configured transmission resource pool(s) may be used for relay discovery and/or sidelink communication.

For U2N remote WTRU 450 (including both in-coverage and out of coverage cases) connected to the network via a U2N relay WTRU 460, only resource allocation mode 2 may be used for discovery message transmission. For mode 1 operation, gNB may allocate the resources the WTRU uses. For mode 2 operation, the WTRU may autonomously select from a pool of resources.

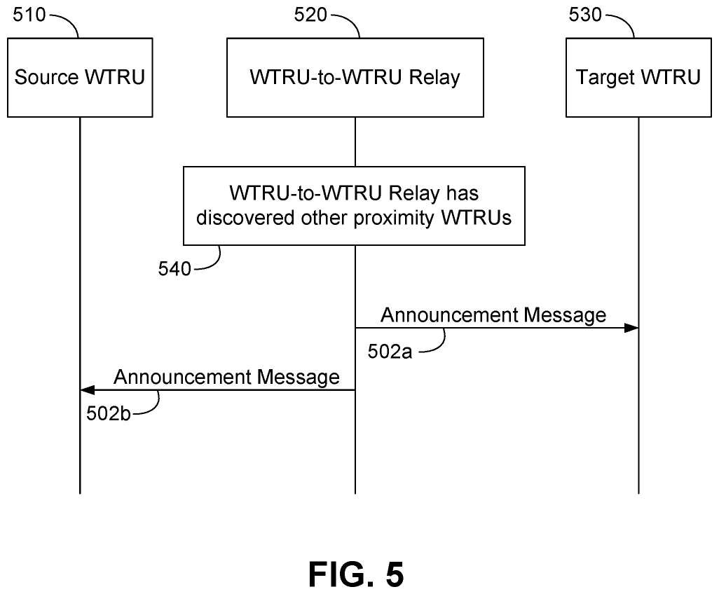

A WTRU may support two different discovery procedures to discover and/or eventually select a WTRU-to-Network relay. FIG. 5 depicts the first such procedure, referred to as model A discovery. In this model A procedure, a WTRU-to-WTRU relay WTRU 520 may discover other WTRUs in its proximity. The WTRU-to-WTRU relay WTRU 520 may send and/or broadcast announcement messages 502a-b to a source WTRU 510 (e.g., the remote WTRU) and/or a target WTRU 530 (e.g., another remote WTRU). The WTRU-to-WTRU relay WTRU 520 may discover other WTRUs in its proximity via either direct discovery and/or direct communication procedures as depicted at 540.

The announcement messages 502a-b may include the type of discovery message, user info ID of the relay, relay service code, user info ID of the proximity WTRUs, and/or potentially other information available to relay WTRU (e.g., relay load, etc.) The remote WTRU (e.g., the source WTRU 510 and/or the target WTRU 530) then may use this information to select the relay WTRU 520.

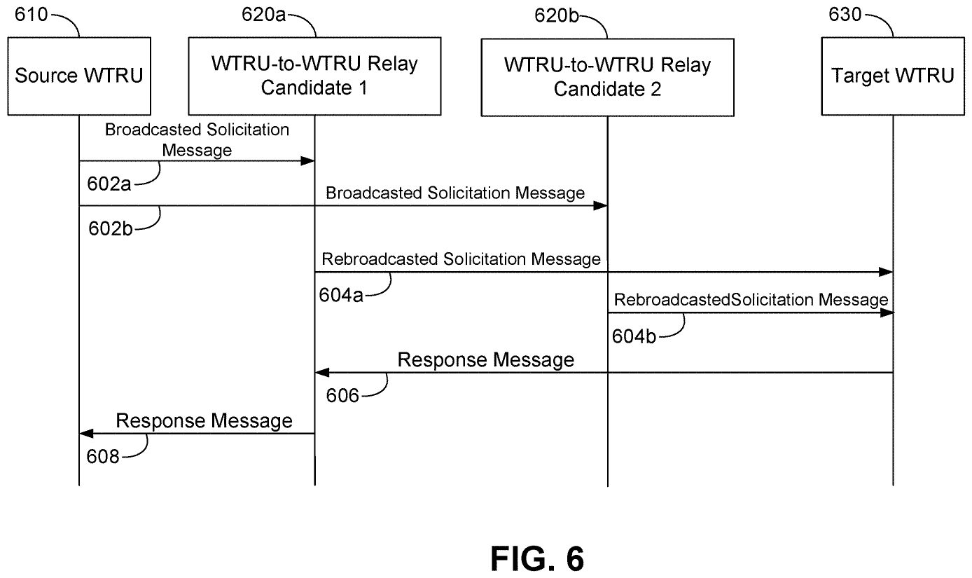

In the second procedure, a source WTRU 610 (e.g., the remote WTRU) that wants to communicate with a target WTRU 630 (e.g., another remote WTRU), may broadcast a solicitation message 602a-b to one or more candidate relay WTRUs 620a-b. FIG. 6 depicts this second such procedure, referred to as model B discovery. The solicitation message 602a-b may include the type of discovery message, user info ID of this source WTRU 610, user info ID of the target WTRU 630, and/or relay service. When one or more candidate relays 620a-b receive(s) the solicitation message(s) 602a-b, the one or more candidate relays 620a-b may then re-broadcast the solicitation message(s) 604a-b. The target WTRU 630 may choose a relay from the received candidate relays 620a-b. The target WTRU 630 may receive the forwarded solicitation message(s) 602a-b based on different parameters (e.g., signal strength). At 606, the target WTRU 630 may respond to this relay WTRU 620a-b. At 608, the relay WTRU 630 may then respond to the source WTRU 610. For WTRU-to-WTRU relay, the Release 18 SA2 conclusion was to support model A and/or model B discovery.

The U2N remote WTRU may perform radio measurements at PC5 interface. The U2N remote WTRU may use the measurements for U2N relay selection and/or reselection along with higher layer criteria. Without a unicast PC5 connection between the U2N relay WTRU and/or the U2N remote WTRU, the U2N remote WTRU may use sidelink discovery reference signal receive power (SD-RSRP) measurements to evaluate whether PC5 link quality with a U2N relay WTRU satisfies relay selection criterion.

Regarding relay reselection, the U2N remote WTRU may use SL-RSRP measurements towards the serving U2N relay WTRU for relay reselection trigger evaluation. The U2N remote WTRU may use SL-RSRP measurements when the U2N relay WTRU transmits data to the U2N remote WTRU. WTRU implementation may determine whether to use SL-RSRP and/or SD-RSRP for relay reselection trigger evaluation in case of no data transmission from U2N relay WTRU to U2N remote WTRU.

A U2N remote WTRU may consider a U2N relay WTRU in terms of radio criteria if the PC5 link quality measured by U2N remote WTRU towards the U2N relay WTRU exceeds a configured threshold. That threshold may be pre-configured and/or provided by gNB. The U2N remote WTRU may search for suitable U2N relay WTRU candidates that meet all AS layer and higher layer criteria. The U2N remote WTRU implementation may choose one U2N relay WTRU among multiple suitable U2N relay WTRUs. For L2 U2N relay (re)selection, the PLMN ID and/or cell ID may be used as additional AS criteria.

The U2N remote WTRU may trigger U2N relay selection when in the following cases: when direct Uu signal strength of the current serving cell of the U2N remote WTRU falls below a configured signal strength threshold, and/or indicated by upper layer of the U2N remote WTRU; PC5 signal strength of the current U2N relay WTRU falls below a preconfigured signal strength threshold; cell (re)selection; handover and/or U2N relay WTRU via PC5-RRC signaling indicates Uu RLF; when remote WTRU receives a PC5-S link release message from U2N relay WTRU; and/or when U2N remote WTRU detects PC5 RLF indicated by the upper layer.

For L2 U2N remote WTRUs in RRC_IDLE/INACTIVE and/or L3 U2N remote WTRUs, the cell (re)selection procedure and/or relay (re)selection procedure may run independently. The WTRU implementation may select either a cell and/or a U2N relay WTRU if both suitable cells and/or suitable U2N relay WTRUs are available. A L3 U2N remote WTRU implementation may select a cell and/or a U2N relay WTRU simultaneously.

For both L2 and/or L3 U2N relay WTRUs in RRC_IDLE/INACTIVE, the PC5-RRC message(s) may be used to inform their connected remote WTRU(s) when U2N relay WTRUs select a new cell. The PC5-RRC message(s) may also be used to inform their connected L2 and/or L3 U2N remote WTRU(s) when L2/L3 U2N relay WTRU performs handover and/or detects Uu RLF. Upon reception of the PC5 RRC message for notification, the U2N remote WTRU implementation may determine whether to release or keep the unicast PC5 link. If U2N remote WTRU decides to release the unicast PC5 link, the U2N remote WTRU may trigger the L2 release procedure and/or may perform relay reselection.

U2N relays may have a very simple connectivity architecture and/or network coverage. Specifically, the remote WTRU may be assumed to be out of coverage while the relay WTRU may be assumed to be in coverage. The remote WTRU may be assumed to have a single unicast link with the relay WTRU. The relay WTRU may have a legacy RRC connection with the network. Finally, the remote WTRU always performs the relay selection and/or reselection procedure so that one WTRU performs the operation.

The U2U relay may have more variations of topology and/or coverage situations, such as one, two, and/or all the WTRUs either in coverage or out of coverage. The U2U relay may include operating in mode1/mode2, resource pool configuration, and/or the same or different relays serving a single source WTRU with multiple connections to different destinations, and vice versa. Furthermore, either remote WTRU may initiate a relay discovery or (re)selection procedure.

Specific to U2U relays, a remote WTRU with a direct PC5 connection and/or an indirect connection (e.g., via a U2U relay) with another remote WTRU may need to select a relay (for the direct to indirect case) and/or a different relay (for the indirect case). The remote WTRU may need to select and/or reselect a relay to continue communicating with this remote WTRU in case of an issue with the existing direct and/or indirect link.

Both remote WTRUs may independently trigger a relay selection, as there is no way to determine with certainty that the other WTRU also triggered the relay selection. Both remote WTRUs' independently triggering a relay selection may result in both WTRUs sending a direct communication request (DCR) message to possibly different relays. WTRUs independently sending a DCR message to different relays may lead to unnecessary messages on SL and/or potentially selecting different relays for communication in different directions. To address these issues, new conditions and/or criteria for discovery message transmission, including selection of appropriate discovery model and/or means to synchronize relay (re)selection between source and/or destination remote WTRUs, may be considered.

A WTRU may determine which discovery model procedure to use based on the AS layer trigger condition (e.g., RLF vs. SL-RSRP threshold) that triggers relay selection.

Specifically, the WTRU may be configured with a PC5 connection with another remote WTRU. The WTRU may be configured with a SL-RSRP threshold for an acceptable link quality and/or a timer associated with the WTRU triggering discovery solicitation.

If the WTRU detects a RLF, the WTRU may transmit a model B solicitation message and/or link modification message including an indication of RLF detection. The WTRU may wait for a response from a relay WTRU indicating that the target has received the solicitation and/or link modification and selected a relay.

If the WTRU detects that the RSRP falls below a configured threshold, the WTRU may initiate relay selection based on received model A announcement messages. The WTRU may select a relay WTRU for communication with the target WTRU (e.g., remote WTRU). The WTRU may send a release message to the WTRU (e.g., target) WTRU. The release message may inform the WTRU to release the PC5-RRC connection and/or inform the remote WTRU that the WTRU has performed relay selection. If, after a configured time duration, the WTRU has not selected a new relay, the WTRU may transmit a model B solicitation message and/or link modification message to initiate relay selection.

Remote WTRUs that communicate, either directly (e.g., using a direct PC5 link) or indirectly (e.g., via a WTRU-to-WTRU relay) may be designated as either a primary or a secondary. This designation may act as a means of identifying which remote WTRU is primarily responsible for triggering relay (re)selection procedure.

Relay selection may be triggered based on detection of PC5-RLF and/or the PC5 RSRP falling below a threshold for the direct link between the remote WTRUs. For the relay (re)selection example, the same AS layer triggers may apply but based on the link between remote WTRU and/or the relay WTRU. In both cases either remote WTRU may trigger (re)selection.

The two AS layer trigger conditions may have an impact on how relay selection triggering and/or discovery need to be performed. In RLF, the remote WTRU may not be able to communicate with its peer. In examples, a way to avoid redundant relay selection by both WTRUs may require the first WTRU that detects the problem to initiate a model B procedure. That first remote WTRU may send a solicitation to initiate relay selection. The peer remote WTRU may then send a response. When SL-RSRP falls below a threshold, communication may still be possible to coordinate which WTRU does the reselection and/or which makes model A feasible without redundant relay selection and/or link establishment procedures.

A WTRU may determine which discovery model procedure to use based on AS layer trigger condition (e.g., RLF vs. SL-RSRP threshold) that is triggering relay selection.

Specifically, a WTRU (e.g., remote WTRU), may be configured with a PC5 connection with another remote WTRU. The WTRU may be configured with a SL-RSRP threshold for an acceptable link quality and/or a timer associated with the remote WTRU triggering discovery solicitation.

The WTRU may detect RLF. If the WTRU detects RLF, the WTRU may transmit a model B solicitation message and/or link modification message including an indication of RLF detection. Moreover, the WTRU may wait for a response from a relay WTRU indicating that the target WTRU has received the solicitation and/or link modification and selected a relay. The RLF may occur on a PC5 connection with the relay WTRU.

The WTRU may detect that the RSRP falls below a configured threshold. If the WTRU detects that the RSRP falls below a certain threshold, the WTRU may initiate relay selection based on received model A announcement messages. Moreover, the WTRU may select a relay WTRU for communication with the target (e.g., remote) WTRU. The WTRU may send a release message to the target WTRU releasing the PC5-RRC connection and/or informing the remote WTRU that it has performed relay selection.

If after a configured time duration, the WTRU has not selected a new relay (e.g. the selection for the PC5 connection), WTRU may transmit a model B solicitation message and/or link modification message to initiate relay selection.

A remote WTRU may choose which model to select based on cause of reselection and/or AS layer conditions. In examples, the WTRU may choose whether to listen and/or wait for announcement messages, using these announcement messages to perform relay selection (e.g., model A) versus sending a solicitation to initiate a relay selection requiring other remote WTRUs to respond (e.g., model B). Choosing an option may depend on which of the two remote WTRUs needs to trigger relay selection and/or conditions that triggered the (re)selection at the remote WTRU.

If a remote WTRU triggers (re)selection but does not see any model A announcements for relay selection, the remote WTRU may transmit a model B solicitation message to elicit U2U relay response. If a remote WTRU triggers (re)selection and the frequency and/or the periodicity of the model A announcement indicates a potentially outdated announcement and/or the need for an updated model A discovery, the remote WTRU may transmit a model B solicitation message to elicit U2U relay response.

A remote WTRU may choose which model to select based on cause of reselection. If the remote WTRU detects RLF, the remote WTRU may use model B based solicitation for relay selection. Model B based solicitation may allow the remote WTRU to inform the other remote WTRU of the problem.

If the remote WTRU detects RSRP below a threshold, the remote WTRU may utilize one or more existing announcement messages to perform relay (re)selection and/or send a release to the peer remote WTRU. The release may inform the peer remote WTRU that the remote WTRU is performing the (re)selection. The remote WTRU may send a message (e.g. an announcement message) to the peer WTRU to inform the peer WTRU that the remote WTRU has performed relay selection. MIn this instance, the remote WTRU may be unable to select a new relay (e.g., due to not hearing any announcements). The remote WTRU may trigger a solicitation to initiate relay selection. This trigger may be based on a timer (e.g., a pre-configured timer) associated with triggering discovery solicitation. The timer may start the moment remote WTRU detects the RSRP below an acceptable link threshold.

A remote WTRU may choose which model to select based on RSRP. In examples, (re)selection may be triggered, and an RSRP threshold (e.g., for acceptable link quality) may be configured. If the observed RSRP is less than this threshold, then the remote WTRU may use Model B based solicitation. The model B may be used as a means of additional redundancy in the relay selection procedure.

If selection is triggered and/or RSRP exceeds the configured threshold, then the remote WTRU may use Model A based solicitation.

If selection is triggered and/or RSRP is below the configured threshold, the remote WTRU may use solicitation to notify the peer remote WTRU of the reselection. Notifying the peer remote WTRU of (re)selection may ensure both remote WTRUs do not independently perform (re)selection.

A remote WTRU may choose which model to select based on whether the remote WTRU is a master/primary. If the master/primary remote WTRU triggers the (re)selection, the remote (WTRU) may use announcement messages to perform relay selection. The designated remote WTRU for selection and/or the peer (e.g., secondary) remote WTRU may not trigger selection on its own. The primary/master remote WTRU may be configured to reconfigure its primary/master designation as a secondary WTRU and/or reconfigure a peer WTRU as the primary/master if the peer WTRU is the secondary WTRU.

If the remote WTRU is not the primary/master, but needs to perform relay selection (e.g., an expired timer and/or arrival of high QoS data, etc.), the remote WTRU may trigger solicitation for relay selection. In this instance, the remote WTRU may indicate the reason triggering relay selection in the solicitation message.

The initial relay selection may always be performed using model B solicitation. While using model B solicitation, the remote WTRUs may indicate conditions related to triggering of the initial selection to the peer remote WTRU. This indication may allow coordination of the initial selection and/or establish a relationship between the two remote WTRUs (e.g., establishing primary/secondary designation for future (re)selection).

A remote WTRU may utilize two types of solicitation messages to initiate relay selection. First, if the remote WTRU is the primary/master, then the remote WTRU may utilize a solicitation to initiate relay selection (e.g. model B), using a default message configuration. The remote WTRU may use this configuration since the remote WTRU may be the only remote WTRU that triggers reselection. If the remote WTRU that triggers (re)selection is not the primary/master, then the WTRU remote may utilize an enhanced solicitation message. This enhanced solicitation message may indicate and/or include additional information in the model solicitation (e.g., reason for triggering reselection such as high QoS data, etc.). This additional information may indicate and/or inform the primary/master WTRU that the primary/master WTRU should hold off on triggering its own (re)selection. The first remote WTRU may send the additional information to a second WTRU to initiate relay selection. The first WTRU may send the additional information to a second WTRU if the first WTRU is a secondary WTRU.

Conditions for triggering reselection, remote WTRU designation (e.g., primary/secondary for triggering purposes), and/or information obtained from other relays available to the remote WTRUs may be used to determine which remote WTRU performs relay (re)selection. These factors may also determine the choice of whether to wait for announcement messages and/or perform relay selection versus sending a solicitation to initiate a relay selection.

A remote WTRU may detect SL-RLF with the current relay. The remote WTRU may trigger relay (re)selection and/or listen for announcement messages to use for relay selection. If the remote WTRU cannot see any announcement messages (e.g., based on a timer), the remote WTRU may initiate a solicitation to initiate announcement response for U2U relays. The remote WTRU may indicate certain information in the solicitation. The information may be based on whether the remote WTRU is the primary/master for relay (re)selection triggering purposes.

An indication from the relay WTRU to a remote WTRU to perform relay (re)selection (e.g., based on an issue detected with the link between the relay and/or the other remote WTRU (e.g., source and/or target), may be taken as an implicit indication to always use solicitation (e.g., model B) to perform relay (re)selection. This indication may be interpreted this way even if there are (e.g. model A) announcement messages that the remote WTRU may hear.

A relay WTRU may temporarily pause announcement messages if the relay detects an issue with one hop (e.g., source and/or target hop). The relay may temporarily pause announcement messages to ensure that the remote WTRU (e.g., either the remote WTRU-relay link that has the issue or the other relay-remote WTRU hop), uses a solicitation-based procedure to initiate relay (re)selection. In this instance, the relay WTRU may choose not to forward announcement message(s) (e.g., its own or from other relay WTRUs), and/or inform other relay WTRUs to cease model A announcements for a certain amount of time.

The link modification procedure may replace the model B discovery model (e.g., solicitation) to trigger the relay (re)selection procedure and/or the relay selection by the remote WTRU receiving the link modification request message.

A first wireless transmit/receive unit (WTRU) may determine an identifier of the first WTRU and/or an identifier of a second WTRU. The first WTRU and/or the second WTRU may be configured for communication via a PC5 connection. The first WTRU may receive configuration information. The configuration information may include an indication of a time period associated with a relay selection procedure. The first WTRU may determine satisfaction of a trigger condition. The trigger condition may be associated with channel conditions of the PC5 connection with the second WTRU. The first WTRU may determine, based on satisfaction of the trigger condition, whether to initiate a discovery and/or link modification procedure and/or wait the time period associated with the relay selection procedure. The WTRU may make this decision based on a comparison between the identifier of the first WTRU and the identifier of the second WTRU.

The trigger condition may comprise a radio link failure (RLF) of the PC5 connection and/or a sidelink reference signal received power (SL-RSRP) measurement of the PC5 connection falling below a threshold value.

The first WTRU may send a discovery and/or link modification message to initiate the discovery and/or link modification procedure. The first WTRU may make this decision based on a determination that the identifier of the first WTRU is less than the identifier of the second WTRU.

The first WTRU may start a timer for the timer period based on a determination that the identifier of the first WTRU is greater than the identifier of the second WTRU.

The first WTRU may initiate a discovery and/or link modification procedure if the timer period lapses and/or the first WTRU did not receive an indication of relay selection.

The identifier of the first WTRU may include a first layer 2 ID and/or a local ID. The identifier of the second WTRU may include a layer 2 ID and/or a local ID.

The first WTRU may be designated as a primary WTRU. The first WTRU may perform relay selection if the first WTRU: sends a request for the configuration information, the higher layers designate the first WTRU as the primary WTRU without the need for configuration information, and/or based on rules associated with the access stratum (AS) layer.

The rules associated with the AS layer comprise rules associated with quality of service (QOS) flows, channel state information (CSI) associated with the PC5 connection, and/or based on the identifier of the first WTRU and/or the identifier of the second WTRU.

The first WTRU may receive a release message from the second WTRU and/or trigger the relay selection procedure in response to the reception of the release message. The first WTRU may stop a timer associated with the time period based on a reception of a discovery solicitation message indicating that the second WTRU has completed relay selection, and/or based on a determination that channel condition of the PC5 communication have changed.

What is claimed is:

1-20. (canceled)

21. A first wireless transmit/receive unit WTRU comprising:
a processor configured to:
receive configuration information, wherein the configuration information comprises a sidelink reference signal receive power (SL-RSRP) threshold and a time period associated with discovery solicitation;
determine whether radio link failure (RLF) has occurred on a PC5 connection with a second WTRU or whether a SL-RSRP measurement on the PC5 connection is below the SL-RSRP threshold;
based on a determination that RLF has occurred on the PC5 connection with the second WTRU, send a solicitation message or a link modification message, wherein the solicitation message or the link modification message comprises an indication of RLF detection on the PC5 connection; and
based on a determination that the SL-RSRP measurement on the PC5 connection is below the SL-RSRP threshold, send the solicitation message to initiate relay selection after a determination that the first WTRU has not selected a relay WTRU for the PC5 connection during the time period associated with discovery.

22. The first WTRU of claim 21, wherein, in response to the determination that RLF has occurred on the PC5 connection with the second WTRU, the processor is configured to:
wait for a response from a relay WTRU, wherein the response indicates that the second WTRU has received the solicitation message or the link modification message and indicates that the second WTRU has selected the relay WTRU for performing sidelink communication with the first WTRU.

23. The first WTRU of claim 21, wherein the processor is configured to monitor for announcement messages from one or more relay WTRUs during the time period associated with discovery solicitation.

24. The first WTRU of claim 21, wherein the processor is configured to send an indication message to the second WTRU, the indication message indicating that the first WTRU has performed relay selection.

25. The first WTRU of claim 21, wherein the processor is configured to:
configure the first WTRU as a primary WTRU, wherein the primary WTRU performs relay selection.

26. The first WTRU of claim 25, wherein the processor is configured to send one or more announcement messages to perform relay selection.

27. The first WTRU of claim 26, wherein the processor is configured to switch the primary configuration and secondary configurations of the first WTRU and the second WTRU.

28. The first WTRU of claim 21, wherein the processor is configured to:
send a solicitation message and a message comprising the reasons for triggering reselection or quality of service (QOS) data to the second WTRU to initiate relay selection if the first WTRU is a secondary WTRU.

29. A method implemented by a first wireless transmit/receive unit (WTRU), the method comprising:
receiving configuration information, wherein the configuration information comprises a sidelink reference signal receive power (SL-RSRP) threshold and a time period associated with discovery solicitation;
determining that radio link failure (RLF) has occurred on a PC5 connection with a second WTRU; and
based on a determination that RLF has occurred on the PC5 connection with the second WTRU, sending a solicitation message or a link modification message, wherein the solicitation message or the link modification message comprises an indication of RLF detection on the PC5 connection.

30. The method of claim 29, wherein, in response to the determination that RLF has occurred on the PC5 connection with the second WTRU, further comprising:
waiting for a response from a relay WTRU, wherein the response indicates that the second WTRU has received the solicitation message or the link modification message and indicates that the second WTRU has selected the relay WTRU for performing sidelink communication with the first WTRU.

31. The method of claim 29, further comprising:
sending an indication message to the second WTRU, the indication message indicating that the first WTRU has performed relay selection.

32. The method of claim 29, further comprising:
configuring the first WTRU as a primary WTRU, wherein the primary WTRU performs relay selection.

33. The method of claim 32, further comprising:
sending one or more announcement messages to perform relay selection.

34. The method of claim 33, further comprising:
switching the primary configuration and secondary configurations of the first WTRU and the second WTRU.

35. A method implemented by a first wireless transmit/receive unit (WTRU), the method comprising:
receiving configuration information, wherein the configuration information comprises a sidelink reference signal receive power (SL-RSRP) threshold and a time period associated with discovery solicitation;
determining that a SL-RSRP measurement on the PC5 connection is below the SL-RSRP threshold;
sending a solicitation message to initiate relay selection after a determination that the first WTRU has not selected a relay WTRU for the PC5 connection during the time period associated with discovery solicitation, based on a determination that the SL-RSRP measurement on the PC5 connection is below the SL-RSRP threshold.

36. The method of claim 35, further comprising:
monitoring for announcement messages from one or more relay WTRUs during the time period associated with discovery solicitation.

37. The method of claim 35, further comprising:
sending an indication message to the second WTRU, the indication message indicating that the first WTRU has performed relay selection.

38. The method of claim 35, further comprising:
configuring the first WTRU as a primary WTRU, wherein the primary WTRU performs relay selection.

39. The method of claim 38, further comprising:
sending one or more announcement messages to perform relay selection.

40. The method of claim 39, further comprising:
switching the primary configuration and secondary configurations of the first WTRU and the second WTRU.
